(19) United States
(12) Patent Application Publication
(10) Pub. No.: US 2013/0155962 A1
(43) Pub. Date: Jun. 20, 2013

(54) Mechanism for Resource Allocation and Transmission of Control Information to Communication Device

(71) Applicants: Sami-Jukka HAKOLA, Kempele (FI); Samuli Turtinen, Ii (FI); Timo Koskela, Oulu (FI); Anna Pantelidou, Oulu (FI)

(72) Inventors: Sami-Jukka HAKOLA, Kempele (FI); Samuli Turtinen, Ii (FI); Timo Koskela, Oulu (FI); Anna Pantelidou, Oulu (FI)

(73) Assignee: Renesas Mobile Corporation, Tokyo (JP)

(21) Appl. No.: 13/329,521

(22) Filed: Dec. 19, 2011

(30) Foreign Application Priority Data
Dec. 16, 2011 (GB) 1121711.4

(51) Int. Cl. H04W 72/04; H04W 74/08

(52) U.S. Cl. 370/329

(57) ABSTRACT

There is provided a mechanism usable for allocating resources and provide control information about a signal to be transmitted by a communication network element such as a D2D device on resources which may be pre-allocated or allocated directly for the signaling. A resource allocation information element is generated which indicates to resources being allocated to a specific communication function, such as D2D. A content or value of a resource allocation field indicates a control information usable for forming a signal to be transmitted via the indicated resources. By means of the value of the resource allocation field, the D2D device derives a signal characteristic or the like of the signal to be transmitted on the indicated resources. The resource indication may be implicit in the form of an indication of a pre-allocated resource, or direct by indicating a dedicated resource.

### BACKGROUND OF THE INVENTION

### Field of the Invention

The present invention relates to a mechanism usable for controlling resource allocation and transmission of control information to a communication network element. In particular, the present invention is related to apparatuses, methods and computer program products providing a mechanism by means of which resources for a specific communication function, e.g. a D2D communication, can be allocated and control information related to a transmission via the allocated resources can be provided from a communication network control element like an eNB or the like to a D2D device, such as a UE.

The following meanings for the abbreviations used in this specification apply:

ACK: acknowledgement

ARQ: automatic repeat request

BS: base station

C-RNTI: cell RNTI

D2D: device-to-device

DCI: downlink control information

DL: downlink

eNB: enhanced node B

EUTRAN: evolved universal terrestrial radio access network

HARQ: hybrid ARQ

ID: identification

IMSI: international mobile subscriber identity

LTE: Long Term Evolution

LTE-A: LTE Advanced

NACK: non-acknowledgement

PDCCH: physical download control channel

PRACH: physical random access channel

PRB: Physical Resource Block

PUSCH: physical uplink shared channel

RACH: random access channel

RE: resource element

RNTI: radio network temporary identifier

RRC: radio resource control

SR: scheduling request

T-IMSI: temporary IMSI

TTI: transmission time interval

UE: user equipment

UL: uplink

UL-SCH: uplink shared channel

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) communication networks like the Universal Mobile Telecommunications System (UMTS), enhanced communication networks based e.g. on LTE, cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Recently, so-called “proximity-based” applications and services came into the focus of further developments in the field of telecommunications. The term proximity-based applications and services may be used, for example, in cases where two or more communication network devices (i.e. for example two or more users), which are close to each other, are interested in exchanging data, if possible, directly with each other.

For future cellular communication networks, a possible method for such proximity-based applications and services is the so-called device-to-device (D2D) communication functionality. D2D may offer a high communication speed, large capacity and a high quality of service which are important features to be achieved. Advantages achievable by the implementation of D2D communications in the cellular communication environment are, for example, an offloading of the cellular system, reduced battery consumption due to lower transmission power, an increased data rate, an improvement in local area coverage robustness to infrastructure failures and also an enablement of new services. This is possible while also providing access to licensed spectrum with a controlled interference environment to avoid the uncertainties of license exempt band. Due to this, D2D communication gains more and more attraction and interest.

However, in order to make a D2D discovery and communication applicable to communication networks, such as those based on 3GPP LTE or LTE-A systems, it is necessary to evolve a suitable platform in order to intercept the demand of proximity-based applications so that it is possible that devices, such as UEs or the like, can conduct discovery functions and hence establish a D2D communication with each other directly over the air, and potentially communicate directly. Hence, one important task is to provide mechanisms allowing configuration and control of e.g. radio level discovery functionality. This task is to be combined with the requirement to provide a certain level of control for the network operator side. For example, the discovery process needs also to be coupled with a system architecture and a security architecture that allow the 3GPP operators to retain control of the device behavior, for example to control who can emit discovery signals, when and where, what information these signals should carry, and what actions the corresponding devices should take once they discover each other.

### SUMMARY OF THE INVENTION

It is an object of the invention to provide an apparatus, method and computer program product by means of which resources can be allocated and control information for a signal transmission via allocated resources can be provided. In particular, the present invention aims to provide apparatuses, methods and computer program products usable for providing a mechanism by means of which resources for a specific communication function, e.g. a D2D communication, can be allocated and/or control information related to a transmission via allocated resources for a specific communication function, e.g. a D2D communication, can be provided from a communication network control element like an eNB or the like to D2D devices, such as a UE.

This object is achieved by the measures defined in the attached claims.

According to an example of an embodiment of the proposed solution, there is provided, for example, an apparatus comprising a resource allocation information generating portion configured to generate a resource allocation information element comprising at least one resource allocation field indicating resources being allocated to a specific communication function, wherein a content of the at least one resource allocation field indicates a control information usable for forming a signal to be transmitted via the indicated resources, and a resource allocation information transmission portion configured to send the generated resource allocation information element for controlling a transmission using the indicated resources.

Furthermore, according to an example of an embodiment of the proposed solution, there is provided, for example, a method comprising generating a resource allocation information element comprising at least one resource allocation field indicating resources being allocated to a specific communication function, wherein a content of the at least one resource allocation field indicates a control information usable for forming a signal to be transmitted via the indicated resources, and sending the generated resource allocation information element for controlling a transmission using the indicated resources.

In addition, according to an example of an embodiment of the proposed solution, there is provided, for example, an apparatus comprising a receiver configured to receive a resource allocation information element, and a resource allocation information processing portion configured to determine from at least one resource allocation field comprised in the resource allocation information element resources being allocated to a specific communication function and to derive from a content of the at least one resource allocation field a control information usable for forming a signal to be transmitted via the indicated resources.

By virtue of the proposed solutions, it is possible to provide a mechanism usable for allocating resources and providing information about a signal to be transmitted by a communication network element such as a D2D device on resources which may be pre-allocated or allocated directly for the signaling. In other words, it is possible, for example to signal either control information usable for deriving signal characteristics of a specific communication function signaling, such as a D2D discovery or beacon signal which signal may be transmitted on certain implicitly derived resource (i.e. pre-allocated resources), or to signal both an identification of the resources to be used (dedicated resources) and the control information (D2D signal characteristics) for the signal to be transmitted on the dedicated resources. Furthermore, it is possible to us utilize the size of existing control messages, such as of DCI messages, to implement the proposed mechanism.

The above and still further objects, features and advantages of the invention will become more apparent upon referring to the description and the accompanying drawings.

### BRIEF DESCRIPTION OF THE DRAWINGS

FIG. 1 shows a signaling diagram illustrating a procedure for transmitting control information using a DL control channel according to an example of an embodiment of the invention.

FIG. 2 shows a diagram illustrating an example of time/frequency multiplexing of resources.

FIG. 3 shows a diagram of an example of a tree based frequency domain allocation in terms of resource blocks.

FIG. 4 shows flow chart illustrating a procedure conducted by a communication network control element according to an example of an embodiment of the invention.

FIG. 5 shows a flow chart illustrating a procedure conducted by a communication network element according to an example of an embodiment of the invention.

FIG. 6 shows a block circuit diagram of a communication network control element including processing portions conducting functions according to examples of embodiments of the invention.

FIG. 7 shows a block circuit diagram of a communication network element including processing portions conducting functions according to examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP LTE system. However, it is to be noted that the present invention is not limited to an application using such types of communication system, but is also applicable in other types of communication systems and the like.

A basic system architecture of a communication network where examples of embodiments of the invention are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station (BS) or eNB, with which a communication network element or device such as a UE or another device having a similar function, such as a modem chipset, a chip, a module etc., which can also be part of a UE or attached as a separate element to a UE, or the like, is capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication connection to or from a communication network element like a UE or a communication network control element like an eNB, besides those described in detail herein below.

Furthermore, the described network elements, such as communication network elements like UEs or communication network control elements like BSs or eNBs, and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

As described above, according to examples of embodiments of the invention, control information usable for setting characteristics of a signal to be transmitted in or for a specific communication function is provided to a communication network element by using a DL control channel.

According to examples of embodiments of the invention, the specific communication function is a D2D communication where the communication network device, such as a UE, is capable of communicating in the D2D mode. As indicated above, for enabling configuration and control of D2D discovery function, when a D2D device like a UE is in an RRC_CONNECTED state, D2D discovery signals may be transmitted during periods where available resources are not required for “normal” cellular mode, for example during guard time periods of PRACH on the allocated PRACH resources. It is possible that on those resources a signal having length of at least one symbol in time and an amount of subcarriers equal to the subcarriers allocated for PRACH may be sent, i.e. 72 subcarriers. Therefore, the allocation of certain discovery signal resources is possible without explicitly requiring additional resources from the system in UL.

Another possibility may be to multiplex signals for the specific communication function, such as D2D discovery or preamble signals together with PRACH even when the signals are not orthogonal to each other. This is possible for example according to the current specifications such as for LTE where concurrent RACH and UL-SCH transmissions on the same resources are allowed. For example, synchronous non-adaptive hybrid-ARQ retransmissions may overlap with the random access region wherein a suitable implementation is required to handle this, either by moving the retransmissions in the frequency domain or by handling the interference at the eNB receiver.

Another example of resource allocation, for example for D2D specific signals in RRC_CONNECTED state, may be based on an allocation of dedicated resources. Specifically, in the RRC_CONNECTED state, all the aforementioned resources may be used for e.g. eNB-controlled beaconing of certain possible D2D links prior to setting up the D2D connection, i.e. after D2D devices have already discovered each other by corresponding means, such as either via the radio or network level discovery procedures.

It is to be noted that aforementioned resources such as PRACH resources of the like may not suit for general discovery resources to be shared among devices in the system that are in different communication modes, such as in RRC_IDLE and RRC_CONNECTED states.

One possible DL control channel for carrying control information etc. according to examples of embodiments of the invention is the PDCCH. The PDCCH has several purposes, for example to convey scheduling decisions to UEs, i.e. scheduling assignments for UL and DL. The information carried on a PDCCH is referred to as downlink control information (DCI). Depending on the purpose of the control message, different formats of DCI may be defined which may also have different sizes (for example, DCI format 1 may be used for the assignment of a DL shared channel resource when no spatial multiplexing is used (i.e. the scheduling information for one code word only)). The information provided contains everything what is necessary for the UE to be able to identify the resources where to receive the PDSCH in that subframe and how to decode it, for example. Besides the resource block assignment, this may also include further control information, e.g. on the modulation and coding scheme and on the hybrid ARQ protocol.

DCI format 0 or 4 may be used, for example, for UL scheduling grant, wherein DCI format 4 supports UL spatial multiplexing. The resource allocation scheme for uplink may be, for example, a single-cluster allocation where the resource blocks are contiguous in the frequency domain. However, it is to be noted that in current version, such as LTE release 10, support for multi-cluster transmissions of up to two clusters on a single component carrier is provided.

It is to be noted that DCI format 0 has the same size control signaling message as the downlink assignment (DCI format 1A). A flag in the message may be used to inform the terminal (i.e. a UE) whether the message is an uplink scheduling grant (DCI format 0) or a downlink scheduling assignment (DCI format 1A).

In this context, it is to be noted that in the design of new resource allocation messages it is to be considered whether a new message has the same size as existing ones, wherein the difference in the meaning of the message may be indicated via other means, such as re-interpreting certain fields, or is defined as a totally new message with a new message size. The latter approach may have a negative impact on the number of required blind decoding attempts of PDCCH and thus eventually might be an undesirable option. Therefore, also in view of advantages achievable by examples of embodiments of the present invention, a new message having the same size as existing ones may be tried to be achieved.

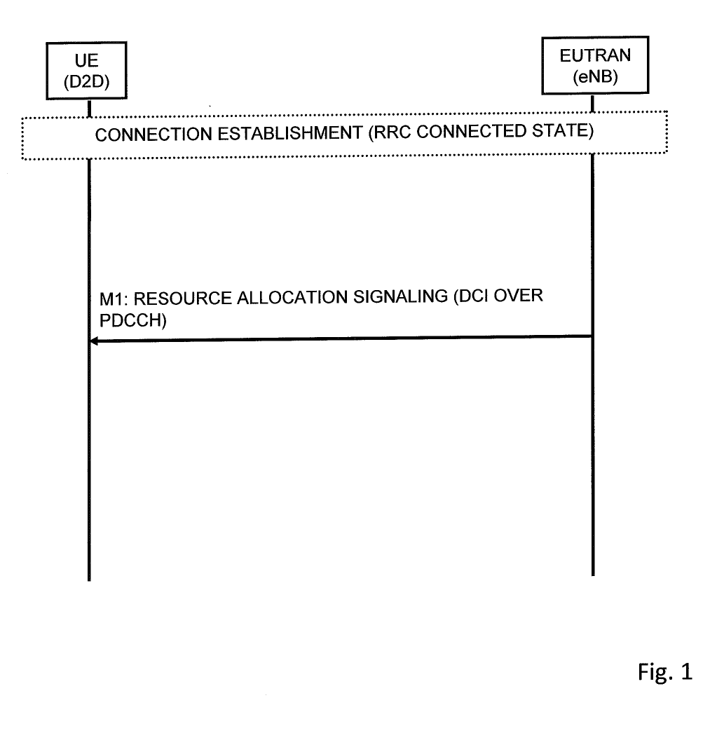

With regard to FIG. 1, a signaling diagram is shown which illustrates a procedure for transmitting messages in a DL control channel, such as a PDCCH, between a controlling communication network control element such as an eNB and a controlled communication network element such as a UE which is usable also for a specific communication function, such as D2D communication.

First, a connection establishment procedure is conducted after which the UE is in a connected state, such as an RRC_CONNECTED state.

In message M1, the eNB sends control signals to the UE for configuring communication settings, for example. In the example indicated in FIG. 1, this is done by a resource allocation signaling in the form of one or more DCI over PDCCH.

According to examples of embodiments of the invention, regarding resources in periods where no signaling in a regular cellular transmission is conducted, for example during a guard time period on PRACH or the like, signaling concerning the specific communication function, such as a discovery related signaling or the like for D2D communication may be conducted. For this purpose, the eNB may send control information to a D2D capable communication network element so as to determine/allocate resources for this D2D specific signaling and/or to provide information about the signal to be transmitted by the D2D device on the resources.

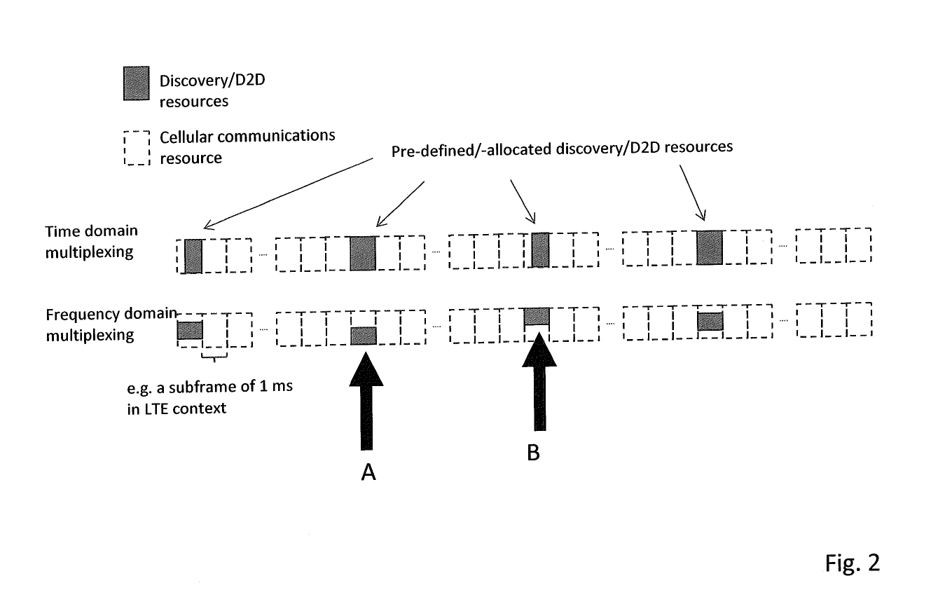

FIG. 2 shows a diagram illustrating an example of time/frequency multiplexing of resources. Specifically, FIG. 2 shows in a simplified manner resources in a time/frequency domain which are allocated to different communication functions, i.e. to a normal e.g. cellular communication (indicated by dashed boxes) and a specific D2D communication (indicated by grey boxes). The resources are defined by subframes of e.g. 1 ms length and comprises plural frequency subcarriers (not shown), e.g. 12. As indicated in FIG. 2, it is assumed that there are predefined or pre-allocated resources for discovery or D2D communications (i.e. the grey resource elements) multiplexed with resources used for normal cellular communications (i.e. the dashed boxes). Multiplexing may be done in time, frequency, and/or space domain. In the diagram of FIG. 2, the upper line of resources illustrates a time domain multiplexing scheme while the lower line indicates a frequency domain multiplexing scheme.

According to examples of embodiments of the invention, resources being pre-allocated for discovery or D2D communication function may be periodical, wherein the resources to be used for the discovery or D2D communication are informed to the UE by the eNB with system information transmitted to the UE. It is to be noted that such resources may be allocated in DL and UL for the specific communication function such as D2D.

According to one example of an embodiment of the invention, which is referred to hereinafter also as example A, the network, such as a communication network control element like an eNB, sends a message in the form of a resource allocation information message, e.g. a DCI message, in which the resource allocation field indicates resources within a predefined discovery or D2D resource. This is indicated by arrow “A” in FIG. 2, for example. The content of the resource allocation field, i.e. a value indicate therein or the like, is used by the receiving UE, that is by the D2D device to which the DCI message was sent, as control information, i.e. to derive e.g. certain characteristics of the signal to be transmitted on those resources.

According to a further example of an embodiment of the invention, which is referred to hereinafter also as example B, the network (e.g. eNB) is configured to send a resource allocation information element (DCI message) with two resource allocations fields (e.g. as DCI format 4). The first resource allocation field may indicate explicit resources for certain D2D related transmission. This is indicated by arrow “B” in FIG. 2, for example. The content of the second resource allocation field may be used by the D2D device to which the DCI message was sent to derive control information for the transmission on the dedicated resources, i.e. certain characteristics of the signal to be transmitted on the resources indicated in the first resource allocation field.

As indicated above, by system information, the network is able to indicate for example periodical resources for discovery or D2D specific communication. This can be seen as a slowly changing allocation method. On the other hand, by using the resource allocation information element signaling, such as the DCI message both in downlink and uplink, a fast resource allocation mechanism may be implemented.

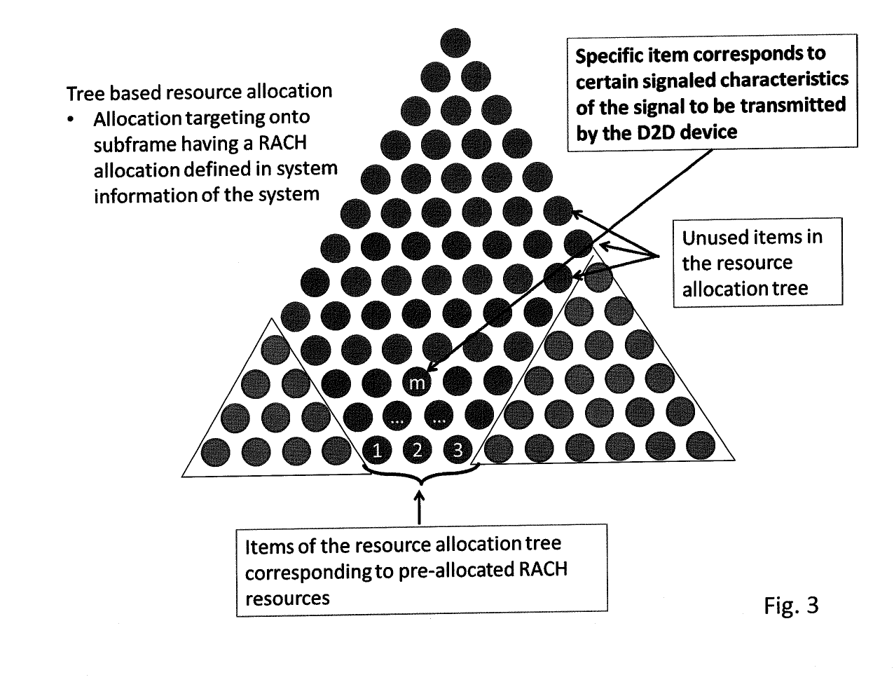

FIG. 3 shows a diagram of an example of scheme of a tree based frequency domain allocation in terms of resource blocks.

Basically, different approaches for signaling of a frequency domain allocation in terms of a set of resource blocks are conceivable.

In the 3GPP LTE system, for example, two approaches for the signaling are adapted. One of these approaches is a bitmap based solution which is mainly suitable for small system bandwidths. The second of these approaches is tree based approach which is illustrated in FIG. 3. It is to be noted that the tree-based approach, even though more complex, is efficient in terms of signaling overhead for any bandwidth.

Since the number of bits available in the control channel is limited, as an efficient methods for transmitting the required information with a low number of bits, which also allows a localized allocation (UE is allocated a set of consecutive chunks where each chunk is a set of 12 consecutive subcarriers), a distributed chunk allocation (UE is allocated a set of chunks dispersed across its supported bandwidth), and distributed subcarrier allocation (UE is allocated a set of non contiguous subcarriers dispersed across its supported bandwidth), a tree based resource allocation scheme may be implemented. The tree based resource allocation scheme uses a triangular structure as shown in FIG. 3 for resource allocation signaling wherein the number of chunks available for a particular bandwidth is equal to the number of leaf nodes. That is, for a bandwidth with N leaf nodes, the triangle depth equals N and the number of nodes in the tree equal N(N+1)/2. A node number can hence be signaled using ceil(log 2(N*(N+1)/2)) number of bits. As an example, for 20 MHz bandwidth, 13 bits are required (in contrast to a bitmap solution where 100 bits (assuming 100 PRBs) are required). It is to be noted that in LTE based systems the tree based method is used for uplink resource allocations, for example.

According to examples of embodiments of the invention, when using the tree based resource allocation method as indicated in FIG. 3, the allocation targets on subframes having e.g. a RACH allocation which is defined in the system information provided by the network to the UE. These elements are localized, for example, in the middle of the triangle (the smaller triangles indicated on the lower left and right sides are related, for example, to resources used for other purposes and are not considered here), wherein several thereof are unused at the moment. As indicated in FIG. 3, one specific item may be selected and set such that its content corresponds to a certain characteristic (control information) to be transmitted to the D2D device (UE) for the signal to be transmitted on the resource (pre-allocated resource, for example), to which the item is related.

When using the tree based resource allocation, referring back to example A shown and discussed in connection with FIG. 2, according to an example of an embodiment of the invention, in an uplink resource allocation signaling, such as a DCI signaling, portions of the message corresponding to nodes which are left unused for the subframes on which e.g. RACH resources are allocated are used to convey common or even dedicated control information. As a more specific example, a D2D device or UE in the RRC_CONNECTED state is scheduled by the eNB to transmit a certain D2D specific signal, for instance a discovery, beacon or preamble signal, on interference-free PRACH resources as indicated or allocated, in the region of PRACH resources or on dedicated resources wherein control information is provided indicating a certain characteristic of the signal, such as a cyclic shift, orthogonal cover code, or the like, which characteristic is derivable from the signaled node value.

In a modification of the above example of an embodiment of the invention, the unused tree nodes may be used to signal certain characteristics of a signal to be transmitted by the D2D device in an uplink resource allocation message wherein the resources is not restricted to a PRACH pre-allocated resource but may be any predefined/pre-allocated D2D discovery resources.

According to examples of embodiments of the invention, in the UE side (D2D device) which receives the resource allocation information element or message with the indications for resources/signal characteristics for the specific communication function, according to the example A, the D2D device being in the RRC_CONNECTED state knows the RACH allocations from the system information provided by the eNB. Thus, for example, in a subframe n−k, where k is 4 and thus corresponds to the subframe used to allocate uplink resources for the subframe n, the device may be configured to conduct the following processing. In case the D2D device (UE) receives an uplink resource allocation message (DCI) on PDCCH and if it is determined that the resource indication field given in the allocation message corresponds to the resource block used by PRACH on that certain subframe, the signaled value is read and processed so as to derive a certain characteristics of the scheduled discovery or preamble signal, e.g. a cyclic shift of the signal.

Example A may be implemented in LTE based systems, for example, by using the uplink resource allocation type 0 where the resource block groups are indicated which are allocated to the scheduled UE or D2D device, where an resource block group is a set of consecutive resource block groups.

On the other hand, referring back to example B shown and discussed in connection with FIG. 2, according to an example of an embodiment of the invention, the resource allocation signaling may be nested, i.e. comprising double resource allocation indication values. The first resource allocation indication value may indicate explicitly which resources are to be used for a specific communication function, such as a D2D discovery or the like. When it is determined that the second node value is related to the first node value, i.e. is for example located within the resource block range defined by the first value, the UE may interpret this in such a manner that the second value provides control information, e.g. gives certain characteristics of the signal to be transmitted on the resources indicated in first value. For example, a D2D discovery signaling or D2D sounding signal to test possible D2D links may utilize example B where the eNB schedules the device on certain resources with the first value and the signal to be transmitted is to be shaped according to the second value.

In a modification of the above example of an embodiment of the invention, the communication network control element (e.g. the eNB) may send a signal by using the above nested indication approach so as to allocate the resources for the D2D discovery or beacon signaling for all available D2D devices by means of the first value and wherein as the second value a kind of a randomizing seed or the like is provided. By means of this randomizing seed, by using a unique value stored in the respective UE, for example the unique value of the ID which each device has, control information such as characteristics for the D2D discovery or preamble signal on allocated resources given by the first value can be derived with a suitable algorithm. For example, the unique value or ID of a UE may be could be C-RNTI, T-IMSI, or the like.

It is to be noted that example B may be implemented by using, for example, in an LTE based system the resource allocation type 1 designed for multi-cluster resource allocation (e.g. in 3GPP LTE Release 10) where individual resource block groups can be addressed so as to increase the flexibility in spreading the resources.

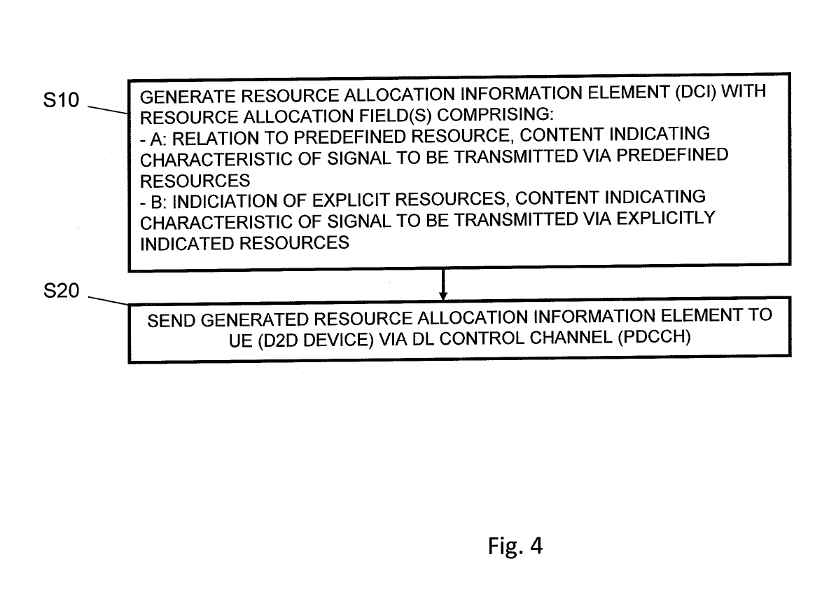

FIG. 4 shows a flow chart illustrating a procedure conducted by a communication network control element, such as an eNB as shown in FIG. 1, according to an example of an embodiment of the invention.

In step S10, the eNB generates a resource allocation information element such as a DCI comprising at least one resource allocation field which indicates resources being allocated to a specific communication function (e.g. D2D discovery or the like).

In case an example according to example A is implemented, this means that a relation to a predefined or pre-allocated resource (PRACH resource or the like) is generated and that a content of the at least one resource allocation field is set such that it indicates a control information usable for forming a signal to be transmitted via the indicated resources (i.e. a characteristic of the signal to be transmitted is derivable from the value). It is to be noted that the eNB may be configured to transmit corresponding system information indicating the predefined resources beforehand to the UE (not shown in FIG. 4).

Otherwise, in case an example according to example B is implemented, a first resource allocation field indicates explicitly to a resource to be used for signaling in the specific communication function (D2D discovery or the like) while a content of a second resource allocation field is set such that it indicates a control information usable for forming the signal to be transmitted via the resources indicated in the first resource allocation field (i.e. a characteristic of the signal to be transmitted is derivable from the value, a randomizing seed, or the like).

In step S20, the generated resource allocation information element (DCI) for controlling a transmission using the indicated resources is sent to the UE, e.g. via the PDCCH.

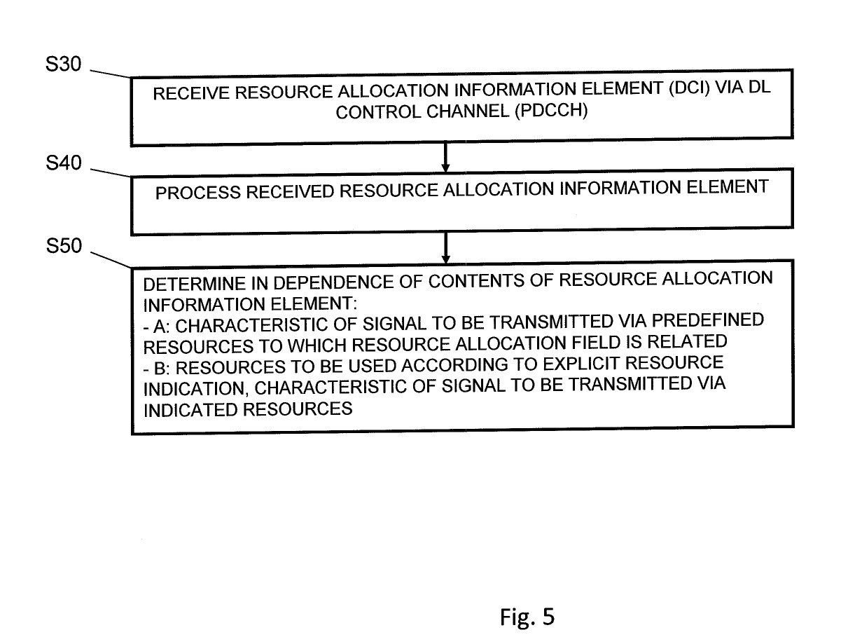

FIG. 5 shows a flow chart illustrating a procedure conducted by a communication network element such as a UE being capable for a D2D communication as shown in FIG. 1, according to an example of an embodiment of the invention.

In step S30, the UE receives a resource allocation information element (DCI).

In step S40, the UE processes the information contained in the resource allocation information element (DCI) so as to determine in step S50 the information comprised in the resource allocation information element (DCI) for the signaling in the specific communication function (D2D). That is, in case an example according to example A is implemented, a relation of information in a resource allocation field to a predefined or pre-allocated resource (PRACH resource or the like) is recognized and a content (value) of the at least one resource allocation field is used for deriving a control information usable for forming a signal to be transmitted via the indicated resources (i.e. a characteristic of the signal to be transmitted is derivable from the value). It is to be noted that the UE may have received corresponding system information indicating the predefined resources beforehand from the eNB (not shown in FIG. 5).

Otherwise, in case an example according to example B is implemented, a first resource allocation field is processed to determine explicit resources to be used for signaling in the specific communication function (D2D discovery or the like) and a second resource allocation field is used to determine from the value thereof a control information usable for forming the signal to be transmitted via the resources indicated in the first resource allocation field (i.e. a characteristic of the signal to be transmitted is derivable from the value, a randomizing seed, or the like).

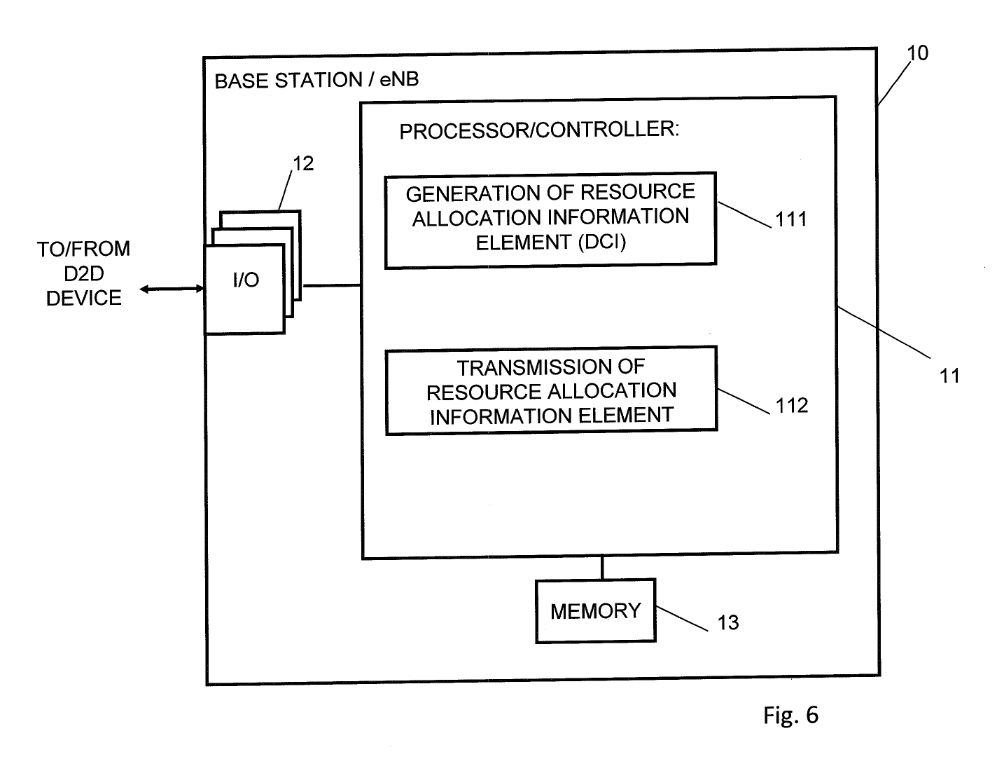

In FIG. 6, a block circuit diagram illustrating a configuration of a communication network control element, such as an eNB, is shown, which is configured to implement the processing for allocating resources and transmitting control information related to a specific communication function such as a D2D communication function as described in connection with the examples of embodiments of the invention. It is to be noted that the communication network control element or eNB 10 shown in FIG. 6 may comprise several further elements or functions besides those described herein below, which are omitted herein for the sake of simplicity as they are not essential for understanding the invention. Furthermore, even though reference is made to an eNB, the communication network element may be also another device having a similar function, such as a modem chipset, a chip, a module etc., which can also be part of a BS or attached as a separate element to a BS, or the like.

The communication network control element or eNB 10 may comprise a processing function or processor 11, such as a CPU or the like, which executes instructions given by programs or the like related to the control signal transmission control. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denote transceiver or input/output (I/O) unit connected to the processor 11. The I/O unit 12 may be used for communicating with a communication network element like a UE. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described mechanism for configuring resources and transmitting control information related to a D2D communication function. In particular, the processor 11 comprises a sub-portion 111 as a processing portion which is usable for generating a resource allocation information element such as a DCI according to the resource allocation and control information introduction mechanisms of examples of embodiments of the invention. The portion 111 may be configured to perform processing according to step S10 according to FIG. 4, for example. Furthermore, the processor 11 comprises a sub-portion 112 usable as a portion for transmitting the resource allocation information element (DCI) generated in portion 111. The portion 112 may be configured, for example, to perform a processing according to step S20 according to FIG. 4, for example.

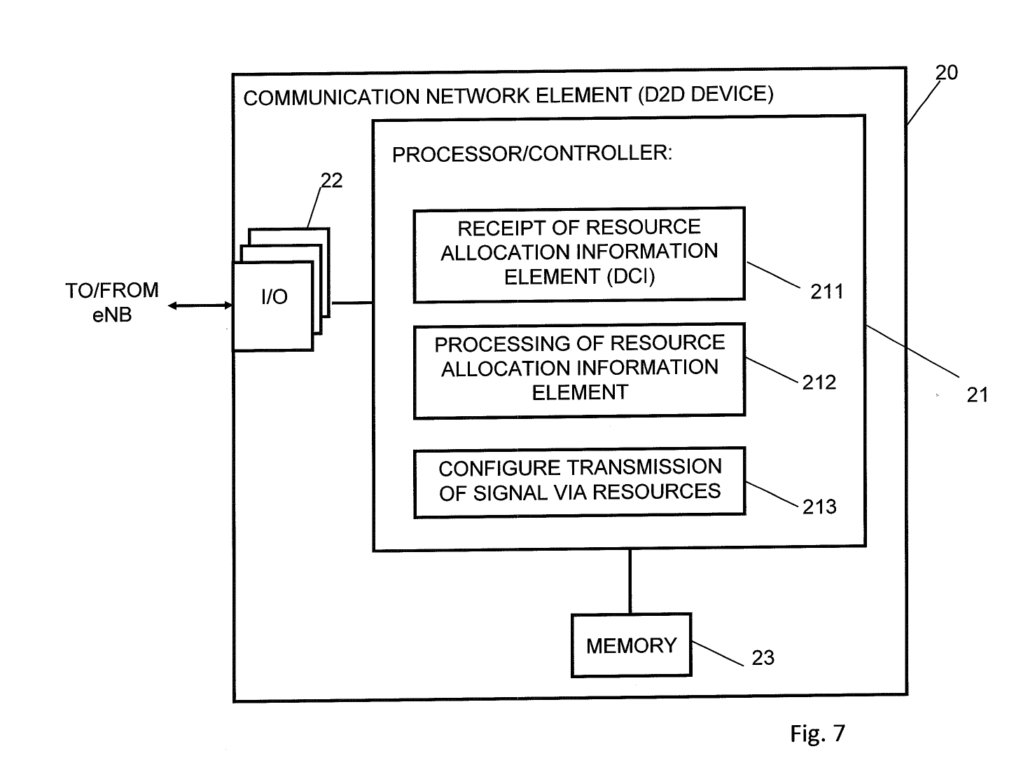

In FIG. 7, a block circuit diagram illustrating a configuration of a communication network element, such as of UE, is shown, which is configured to implement the processing for configuring resources and using a transmitted control information related to a specific communication function such as a D2D communication function as described in connection with the examples of embodiments of the invention, for example. It is to be noted that the communication network device or UE 20 shown in FIG. 7 may comprise several further elements or functions besides those described herein below, which are omitted herein for the sake of simplicity as they are not essential for understanding the invention. Furthermore, even though reference is made to a UE, the communication network element may be also another device having a similar function, such as a modem chipset, a chip, a module etc., which can also be part of a UE or attached as a separate element to a UE, or the like.

The communication network element or UE 20 may comprise a processing function or processor 21, such as a CPU or the like, which executes instructions given by programs or the like related to the control signal transmission control. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 22 denotes transceiver or input/output (I/O) units connected to the processor 21. The I/O units 22 may be used for communicating with elements of the access network, such as a communication network control element like an eNB. The I/O units 22 may be a combined unit comprising communication equipment towards several of the network element in question, or may comprise a distributed structure with a plurality of different interfaces for each network element in question. Reference sign 23 denotes a memory usable, for example, for storing data and programs to be executed by the processor 21 and/or as a working storage of the processor 21.

The processor 21 is configured to execute processing related to the above described mechanism for configuring resources and using control information related to a D2D communication function, for example. In particular, the processor 21 comprises a sub-portion 211 as a processing portion which is usable for receiving a resource allocation information element (DCI) transmitted, for example, from a communication network control element such as a eNB, which comprises the control information and possibly allocation information according to examples of embodiments of the invention. The portion 211 may be configured to perform processing according to step S30 according to FIG. 5, for example. Furthermore, the processor 21 comprises a sub-portion 212 as a processing portion which is usable as a portion for processing the received resource allocation information element. The portion 212 may be configured to perform processing according to step S40 according to FIG. 5, for example. Moreover, the processor 21 comprises a sub-portion 213 as a processing portion which is usable as a portion for configuring a transmission of a signal in the specific communication function, for example a D2D discovery signal, in accordance with the information derived from the resource allocation information element, such as a characteristic of the signal or the resources to be used. The portion 213 may be configured to perform processing according to step S50 according to FIG. 5, for example.

According to a further example of an embodiment of the invention, there is provided an apparatus comprising resource allocation information generating means for generating a resource allocation information element comprising at least one resource allocation field indicating resources being allocated to a specific communication function, wherein a content of the at least one resource allocation field indicates a control information usable for forming a signal to be transmitted via the indicated resources, and resource allocation information transmission means for sending the generated resource allocation information element for controlling a transmission using the indicated resources.

According to a still further example of an embodiment of the invention, there is provided an apparatus comprising receiving means for receiving a resource allocation information element, and resource allocation information processing means for determining from at least one resource allocation field comprised in the resource allocation information element resources being allocated to a specific communication function and for deriving from a content of the at least one resource allocation field a control information usable for forming a signal to be transmitted via the indicated resources.

As described above, examples of embodiments of the invention are described to be implemented in UEs and eNBs. However, the invention is not limited to this. For example, examples of embodiments of the invention may be implemented in a wireless modem or the like.

According to further examples of embodiments of the invention, there is provided, according to an aspect A, a method comprising generating a resource allocation information element comprising at least one resource allocation field indicating resources being allocated to a specific communication function, wherein a content of the at least one resource allocation field indicates a control information usable for forming a signal to be transmitted via the indicated resources, and sending the generated resource allocation information element for controlling a transmission using the indicated resources.

According to an aspect A1, in the method according to aspect A, the control information is used to set a characteristic of the signal to be transmitted, wherein the content of the at least one resource allocation field is set such that the characteristic is derivable therefrom, the characteristic being at least one of a cyclic shift or an orthogonal cover code of the signal to be transmitted.

According to an aspect A2, in the method according to aspect A or A1, the resources being indicated by the at least one resource allocation field are predefined resources being allocated to the specific communication function in advance, wherein the resource allocation information element is related to the predefined resources.

According to an aspect A3, the method according to aspect A2 further comprises transmitting system information indicating the predefined resources beforehand.

According to an aspect A4, in the method according to any of aspects A to A3, the predefined resources are allocated to a random access channel.

According to an aspect A5, the method according to aspect A further comprises generating the resource allocation information element by including, in addition to the at least one resource allocation field, a further resource allocation field forming together with the at least one resource allocation field a nested structure, wherein the further resource allocation field comprises an indication to explicit resources to be allocated to the specific communication function so as to be used for transmitting the signal to be formed.

According to an aspect A6, in the method according to aspect A5, the control information indicated by the content of the at least one resource allocation field is used to set a characteristic of the signal to be transmitted via the resources indicated by the further resource allocation field, wherein the content of the at least one resource allocation field is set such that the characteristic is derivable therefrom, the characteristic being at least one of a cyclic shift or an orthogonal cover code of the signal to be transmitted.

According to an aspect A7, in the method according to aspect A6, the control information represents a randomizing seed which is to be combined with a unique value not being comprised in the resource allocation information element for deriving the characteristic of the signal to be transmitted via the resources indicated by the further resource allocation field.

According to an aspect A8, in the method according to any of aspects A to A7, the specific communication function is related to a device-to-device communication.

According to an aspect A8, in the method according to any of aspects A to A8, the method is implemented in a communication network control element controlling a communication using the specific communication function.

According to still further examples of embodiments of the invention, there is provided, according to an aspect B, a method comprising receiving a resource allocation information element, and processing the resource allocation information element for determining from at least one resource allocation field comprised in the resource allocation information element resources being allocated to a specific communication function and to derive from a content of the at least one resource allocation field a control information usable for forming a signal to be transmitted via the indicated resources.

According to an aspect B1, in the method according to aspect B, the processing further comprises to use the control information to set a characteristic of the signal to be transmitted, wherein the content of the at least one resource allocation field is set such that the characteristic is derivable therefrom, the characteristic being at least one of a cyclic shift or an orthogonal cover code of the signal to be transmitted.

According to an aspect B2, in the method according to aspect B or B1, the resources being indicated by the at least one resource allocation field are predefined resources being allocated to the specific communication function in advance, wherein the resource allocation information element is related to the predefined resources.

According to an aspect B3, the method according to aspect B2 further comprises receiving system information indicating the predefined resources beforehand.

According to an aspect B4, in the method according to aspect B2 or B3, the predefined resources are allocated to a random access channel.

According to an aspect B5, in the method according to aspect B, the processing further comprises to determine from a further resource allocation field included in the resource allocation information element in addition to the at least one resource allocation field, wherein the further resource allocation field forms together with the at least one resource allocation field a nested structure, an indication to explicit resources to be allocated to the specific communication function so as to be used for transmitting the signal to be formed.

According to an aspect B6, in the method according to aspect B5, the processing further comprises to use the control information indicated by the content of the at least one resource allocation field to set a characteristic of the signal to be transmitted via the resources indicated by the further resource allocation field, wherein the content of the at least one resource allocation field is set such that the characteristic is derivable therefrom, the characteristic being at least one of a cyclic shift or an orthogonal cover code of the signal to be transmitted.

According to an aspect B7, in the method according to aspect B6, the processing further comprises to derive the characteristic of the signal to be transmitted via the resources indicated by the further resource allocation field by combing the control information representing a randomizing seed with a unique value available for the resource allocation information processing portion.

According to an aspect B8, in the method according to any of aspects B to B7, the specific communication function is related to a device-to-device communication.

According to an aspect B9, in the method according to any of aspects B to B8, the method is implemented in a communication network element conducting a communication by using the specific communication function.

In addition, according to examples of embodiments of the present invention, according to an aspect C, a computer program product for a computer, comprising software code portions for performing the steps of the above defined methods according to any of aspects A to A8 or B to B8, when said product is run on the computer. The computer program product according to aspect C may further comprise a computer-readable medium on which said software code portions are stored. Furthermore, the computer program product may be directly loadable into the internal memory of the computer and/or transmittable via a network by means of at least one of upload, download and push procedures.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element may be any device, apparatus, unit or means which is usable as a user communication device and by which a system user or subscriber may experience services from an access network, such as a mobile phone, a wireless mobile terminal, a personal digital assistant PDA, a smart phone, a personal computer (PC), a laptop computer, a desktop computer or a device having a corresponding functionality, such as a modem chipset, a chip, a module etc., which can also be part of a UE or attached as a separate element to a UE, or the like, wherein corresponding devices or terminals may be, for example, a LTE, a TETRA (Terrestrial Trunked Radio), an UMTS, a GSM/EDGE etc. smart mobile terminal or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism usable for allocating resources and provide control information about a signal to be transmitted by a communication network element such as a D2D device on resources which may be pre-allocated or allocated directly for the signaling. A resource allocation information element is generated which indicates to resources being allocated to a specific communication function, such as D2D. A content or value of a resource allocation field indicates a control information usable for forming a signal to be transmitted via the indicated resources. By means of the value of the resource allocation field, the D2D device derives a signal characteristic or the like of the signal to be transmitted on the indicated resources. The resource indication may be implicit in the form of an indication of a pre-allocated resource, or direct by indicating a dedicated resource.

Although the present invention has been described herein before with reference to particular embodiments thereof, the present invention is not limited thereto and various modifications can be made thereto.

1. An apparatus comprising
a resource allocation information generating portion configured to generate a resource allocation information element comprising at least one resource allocation field indicating resources being allocated to a specific communication function, wherein a content of the at least one resource allocation field indicates a control information usable for forming a signal to be transmitted via the indicated resources, and
a resource allocation information transmission portion configured to send the generated resource allocation information element for controlling a transmission using the indicated resources.

2. The apparatus according to claim 1,
wherein the control information is used to set a characteristic of the signal to be transmitted, wherein the content of the at least one resource allocation field is set such that the characteristic is derivable therefrom,
the characteristic being at least one of a cyclic shift or an orthogonal cover code of the signal to be transmitted.

3. The apparatus according to claim 1, wherein
the resources being indicated by the at least one resource allocation field are predefined resources being allocated to the specific communication function in advance, wherein the resource allocation information element is related to the predefined resources.

4. The apparatus according to claim 3, wherein the predefined resources are indicated in system information sent beforehand.

5. The apparatus according to claim 3, wherein the predefined resources are allocated to a random access channel.

6. The apparatus according to claim 1, wherein
the resource allocation information generating portion is configured to generate the resource allocation information element by including, in addition to the at least one resource allocation field, a further resource allocation field forming together with the at least one resource allocation field a nested structure, wherein the further resource allocation field comprises an indication to explicit resources to be allocated to the specific communication function so as to be used for transmitting the signal to be formed.

7. The apparatus according to claim 6,
wherein the control information indicated by the content of the at least one resource allocation field is used to set a characteristic of the signal to be transmitted via the resources indicated by the further resource allocation field, wherein the content of the at least one resource allocation field is set such that the characteristic is derivable therefrom,
the characteristic being at least one of a cyclic shift or an orthogonal cover code of the signal to be transmitted.

8. The apparatus according to claim 7, wherein the control information represents a randomizing seed which is to be combined with a unique value not being comprised in the resource allocation information element for deriving the characteristic of the signal to be transmitted via the resources indicated by the further resource allocation field.

9. The apparatus according to claim 1, wherein the specific communication function is related to a device-to-device communication.

10. The apparatus according to claim 1, wherein the apparatus is comprised in a communication network control element controlling a communication using the specific communication function.

11. A method comprising
generating a resource allocation information element comprising at least one resource allocation field indicating resources being allocated to a specific communication function, wherein a content of the at least one resource allocation field indicates a control information usable for forming a signal to be transmitted via the indicated resources, and
sending the generated resource allocation information element for controlling a transmission using the indicated resources.

12. An apparatus comprising
a receiver configured to receive a resource allocation information element, and
a resource allocation information processing portion configured to determine from at least one resource allocation field comprised in the resource allocation information element resources being allocated to a specific communication function and to derive from a content of the at least one resource allocation field a control information usable for forming a signal to be transmitted via the indicated resources.

13. The apparatus according to claim 12,
wherein the resource allocation information processing portion is further configured to use the control information to set a characteristic of the signal to be transmitted, wherein the content of the at least one resource allocation field is set such that the characteristic is derivable therefrom,
the characteristic being at least one of a cyclic shift or an orthogonal cover code of the signal to be transmitted.

14. The apparatus according to claim 12, wherein
the resources being indicated by the at least one resource allocation field are predefined resources being allocated to the specific communication function in advance, wherein the resource allocation information element is related to the predefined resources.

15. The apparatus according to claim 14, wherein the predefined resources are indicated in system information received beforehand.

16. The apparatus according to claim 14, wherein the predefined resources are allocated to a random access channel.

17. The apparatus according to claim 12, wherein
the resource allocation information processing portion is further configured to determine from a further resource allocation field included in the resource allocation information element in addition to the at least one resource allocation field, wherein the further resource allocation field forms together with the at least one resource allocation field a nested structure, an indication to explicit resources to be allocated to the specific communication function so as to be used for transmitting the signal to be formed.

18. The apparatus according to claim 17,
wherein the resource allocation information processing portion is further configured to use the control information indicated by the content of the at least one resource allocation field to set a characteristic of the signal to be transmitted via the resources indicated by the further resource allocation field, wherein the content of the at least one resource allocation field is set such that the characteristic is derivable therefrom,
the characteristic being at least one of a cyclic shift or an orthogonal cover code of the signal to be transmitted.

19. The apparatus according to claim 18, wherein the resource allocation information processing portion is further configured to derive the characteristic of the signal to be transmitted via the resources indicated by the further resource allocation field by combing the control information representing a randomizing seed with a unique value available for the resource allocation information processing portion.

20. The apparatus according to claim 12, wherein the specific communication function is related to a device-to-device communication.

21. The apparatus according to claim 12, wherein the apparatus is comprised in a communication network element conducting a communication by using the specific communication function.
